(19) United States
(12) Patent Application Publication
(10) Pub. No.: US 2011/0164907 A1
(43) Pub. Date: Jul. 7, 2011

(54) SURFACE TREATMENT APPARATUS FOR RECORDING MATERIAL AND IMAGE FORMING APPARATUS

(76) Inventors: Miho YAMANO, Tokyo (JP); Junichi Hamada, Tokyo (JP)

(21) Appl. No.: 12/984,350

(22) Filed: Jan. 4, 2011

(30) Foreign Application Priority Data
Jan. 7, 2010 (JP) JP2010-001828

(51) Int. Cl. G03G 15/20

(52) U.S. Cl. 399/341

(57) ABSTRACT

A surface treatment apparatus for recording material, includes: a resin film to be adhered to a toner image surface of a toner image carried on the recording material after a whole region of the toner image has been heat treated; a heating section including a plurality of heating elements provided on an opposite side of the recording material relative to the resin film; and a control section which controls the heating section, wherein the control section performs a current control of a predetermined part of the plurality of heating elements selectively in a state where the recording material and resin film contacts each other and recording material moves relatively to the heating section.

### RELATED APPLICATION

This application is based on Japanese Patent Application NO. 2010-001828 filed on Jan. 7, 2010 in Japanese Patent Office, the entire content of which is hereby incorporated by reference.

### TECHNICAL FIELD

The present invention relates to a surface treatment apparatus for recording material capable of providing glossiness or printing characters and/or patterns on an arbitrary region of a toner image formed on a recording material, and an image forming apparatus such as a copying machine and a printer mounted with said surface treatment apparatus.

### BACKGROUND

An image forming apparatus such as a copying machine, a printer or a facsimile having a constitution in which a toner image is formed utilizing electrophotographic processes such as charge, exposure and development on an image carrier such as a photoconductor drum and said toner image is fixed on a recording material by a heat treatment after having been transferred on a recording material is well known.

In such an image forming apparatus, in recent years, to improve glossiness of a toner image is intended, and there are many proposals related to an image forming apparatus equipped with a glossiness providing apparatus as a surface treatment apparatus for recording material.

As one of such constitutions, for example, proposed is a fixing apparatus equipped with a glossiness providing mechanism of a two-step roller constitution in which the fixing section is constituted of a heating pre-fixing apparatus (the first fixing section) bearing a heat pre-fixing process and an image glossiness providing apparatus (the second fixing section) bearing an image glossiness providing process.

Specifically, a heat fixing apparatus is constituted of a heating roller building in a heat source and a pressure roller building in a heat source to form a fixing nip portion by being brought in press contact with said heating roller. Further, an image glossiness providing apparatus is constituted of a glossiness providing roller including a heating source the outer surface of which is directly in contact with a heat sink as a cooling section and with an oil coating roller, and a pressure providing roller which forms a pressing nip portion by press contacting with said glossiness providing roller.

And, such a constitution enables to uniformly and highly efficiently cool the second fixing section which provides glossiness on a toner image after heat fixing by the first fixing section, whereby, stable improvement of glossiness of a fixed toner image is possible (specifically, confer JP-A 2007-108464 (hereinafter, JP-A confer Japanese Patent Publication Open to Public Inspection No.)).

However, the above-described proposal is able to improve glossiness of the whole toner image; however, it is not intended to improve glossiness of a partial region of an image.

Against the above-described proposal, the following proposal as a constitution which enables to increase glossiness of a partial region of a toner image has been made. Specifically, it is an image forming apparatus provided with a constitution in which the glossiness of an image pattern is selectively adjusted by adhering an unfixed image carrying surface of a recording material on one surface of a film belt and controlling a fixing temperature as well as arranging at least two heating section (thermal heads) on the other surface of the film belt perpendicular to the proceeding direction of a recording material (specifically, confer JP-A 5-19660). Further, said image forming apparatus is provided with a heat pipe as a cooling body downstream of the aforesaid thermal head.

A glossiness providing technology disclosed in JP-A 5-19660 is useful since it is capable of adjusting glossiness of a toner image partially and in stepwise. However, it cannot provide glossiness on an arbitrary partial region in a toner image and there is room for improvement.

This invention has been made in view of the point as described above, and the primary object is to provide a surface treatment apparatus for a recording material which can provide glossiness, or can provide such as characters, symbols and patterns utilizing a shape of a film belt surface, on an arbitrary region of a toner image.

### SUMMARY

To achieve at least one of the abovementioned objects, a surface treating apparatus of recording material reflecting one aspect of the present invention comprises a resin film to be adhered to a toner image surface of a toner image carried on the recording material after a whole region of the toner image has been heat treated; a heating section including a plurality of heating elements provided on an opposite side of the recording material relative to the resin film; and a control section which controls the heating section, wherein the control section performs a current control of a predetermined part of the plurality of heating elements selectively in a state where the recording material and resin film contacts each other and recording material moves relatively to the heating section.

### BRIEF DESCRIPTION OF THE DRAWINGS

FIG. 1 is an outline drawing to show a constitution of an image forming apparatus comprising a digital color copying machine.

FIG. 2 is an explanation drawing to conceptually show a constitution of a surface treatment apparatus for recording material.

FIG. 3 is a drawing to show the heat surface of a heating section provided with many dotted heating elements which are linearly arranged.

FIG. 4 is an explanation drawing to conceptually show the second embodiment related to a surface treatment of recording material.

FIG. 5 is an explanation drawing to conceptually show the third embodiment related to a surface treatment of recording material.

### DETAILED DESCRIPTION OF THE INVENTION

In the following, an embodiment according to this invention will be explained; however, this invention is not limited thereto.

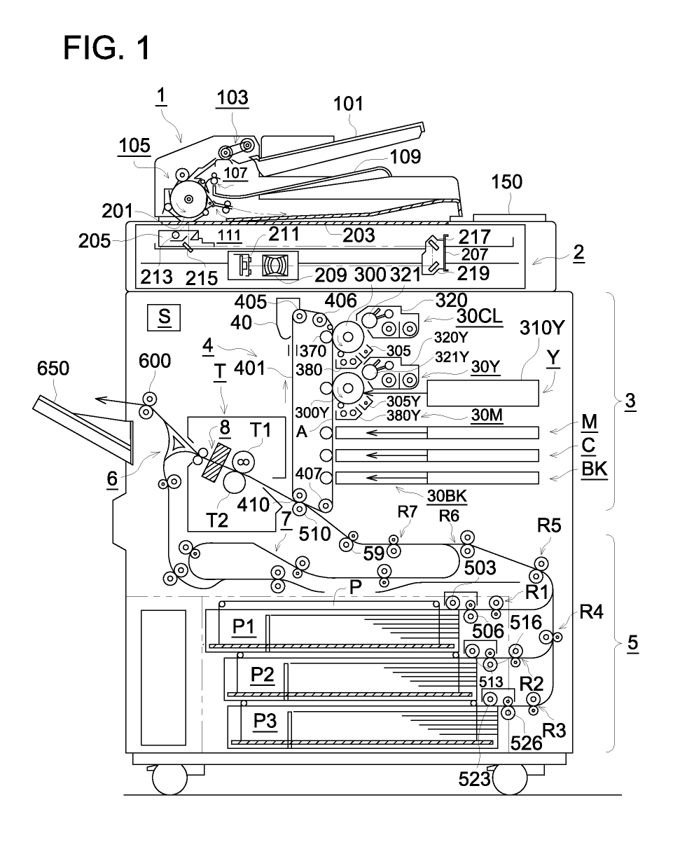

FIG. 1 is an outline drawing to show a constitution of an image forming apparatus comprising a digital color copying machine.

The image forming apparatus shown in the drawing is provided with automatic original feeding apparatus 1 in the upper portion of the apparatus main body, and in addition to this, provided with image reading section 2, image forming section 3, a belt setup section for belt unit 4, paper feeding section 5, fixing apparatus T, paper reversing feed-out•re-feeding section 6 and reversing transport section 7, inside the main body.

Automatic original feeding apparatus 1 is provided with original loading table 101, original separation section 103, original transport section 105, original feed-out section 107, original feed-out table 109, and original reversing section 111 comprising a roller pair to reverse the front and back surfaces of an original in the case of a two-sided copying mode.

The original reading position is arranged in the under part of original transport section 105, where an image of an original is read via slit 201 constituting image reading section 2, and the original having been read is fed out on original feed-out table 109 by original feed-out section 107. Herein, in a two-sided copying mode, the original being conveyed after the one surface having been read is conveyed toward the direction shown by the arrowhead of a two-dotted chain line by aforesaid original reversing mans 111.

And the original is fed out onto original feed-out table 109 by original feed-out section 107, after having been introduced to the original reading position again via original transport section 105 by counter-wise rotation of original reversing section 111 after stopping the drive in a state of the tail end in the proceeding direction of the original being nipped.

Image reading section 2 is provided with slit 201, first mirror unit 205 which comprises a lamp for original illumination 201 and first mirror 215 to reflect the reflective light from an original in one body, and second mirror unit 207 which comprises second mirror 217 and third mirror 219 in one body.

Further, image reading section 2 is provided with focusing lens 209 to focus the reflective light from third mirror 219 on an image capturing element, and image capturing element 211 of a linear form (hereinafter, referred to as a CCD) to perform photoelectric conversion of an optical image focused by focusing lens 209 to obtain image information. Image information is once accumulated in a memory in control section S which will be described later, after having been subjected to an appropriate image processing.

In an embodiment to read an original being sent by automatic original feeding apparatus 1 by image reading section 2, first mirror unit 205 and second mirror unit 207 are fixed at the positions shown in the drawing.

Image information of each color having been read by image reading section 2 and subjected to an image processing is read out in order from a memory and is sent into an exposure optical system of each color, which is an electrostatic latent image forming section, as an electric signal, respectively. Image forming section 3 is provided with 4 sets of image forming section 30 (30Y, 30M, 30C and 30BK: hereinafter referred to as an image forming units) of yellow (Y), magenta (M), cyan (C) and black (BK) to form toner images corresponding to color separation images. Herein, in this patent document, these image forming section are referred to as image forming unit 30 in the case that there is no problem to be referred as a lump. Image forming unit 30 is provided with photoconductor drum 300 as an image carrier, charger 305, exposure optical system 310, development apparatus (development section) 320, transfer section 370 and cleaning section 380 as primary constitution elements.

Since these image forming units 30Y, 30M, 30C and 30BK have basically the same constitution, image forming units of M, C and BK will be shown in a simplified manner and reference symbols will be labeled mainly on image forming unit 30Y to be omitted as for other image forming units. Herein, exposure optical system 310 is an exposure unit constituted of a laser optical system.

Clear toner layer forming unit (hereinafter, referred to simply as a layer forming unit) 30CL to form a transparent resin layer containing no colorants is provided at the upper position of image forming unit 30Y, and it has a constitution almost similar to image forming unit 30. Hereinafter, a clear toner layer will be referred to as clear toner layer CL. Herein, formation of clear toner layer CL may be performed after a toner image has been transferred on a recording material.

In each development apparatus 320, a developer of two-component type containing a carrier comprising magnetic substance particles and a toner which is a non-magnetic substance is stored and said developer is transported to a development region by developer carrier (hereinafter, referred to as a development sleeve for convenience) 321.

Layer forming unit 30CL and image forming unit 30 are arranged along the proceeding direction of one surface (stretching surface) A of intermediate transfer belt 401 having a loop form which constitutes belt unit 4. That is, arranged are layer forming unit 30LC at the upper-stream position, followed by image forming units 30 of yellow (Y), magenta (M), cyan (C) and black (BK) in this order.

Such as intermediate transfer belt 401, support rollers 405, 406 and 407 which hang the intermediate belt rotatable and backup roller 410 constitute belt unit 4.

Backup roller 410 constitutes the second transfer section together with rotatable transfer roller 510 which is arranged opposing to the backup roller sandwiching intermediate transfer belt 401.

A process to form an accumulated toner image on intermediate transfer belt 401 by the above-described constitution will now be briefly explained. When an image forming process starts, photoconductor drum 300 in layer forming unit 30CL is charged by charger 305 to a predetermined polarity. Next, the charged pattern is subjected to a development process by development apparatus 320 to be converted to a clear toner layer CL and transferred onto intermediate transfer belt 401 by an action of transfer section 370. In this embodiment, the region size formed with a clear toner layer CL is formed to be larger than a region size in which regular toner images formed.

After a predetermined time from the start of a clear toner layer forming process, exposure corresponding to the first color signal, that is, an image signal of yellow (Y), is performed by exposure optical system 310Y to form an electrostatic latent image corresponding to said yellow (Y) image on photoconductor drum 300Y. The electrostatic latent image, after having been reversal-developed by development apparatus 320 Y to be converted to a toner image of yellow (Y), is transferred to be accumulated on a clear toner layer CL on intermediate transfer belt 401 by an action of transfer section 370Y.

Further, image formation by other color signals which starts after a predetermined time from the start of image formation by the first color signal is performed by a process similar to that described above utilizing image forming units 30M, 30C and 30BK of magenta (M), cyan (C) and black (BK). Each toner image on a photoconductor drum which has been formed with each image forming unit is transferred in order to be accumulated on the image region where a toner image of yellow (Y) is present to form an accumulated color toner image on intermediate transfer belt 401 making clear toner layer CL as the undermost layer.

The surface of each photoconductor drum after finishing a transfer process is cleaned with cleaning section 380 to be prepared for new image formation.

Returning to explanation of the constitution, in the drawing, S is a control section (hereinafter, referred to also as a control section) including a computer, which contains a program for machinery motions and performs the whole control including such as control according to a series of image forming processes and electric current control of heating elements related to the surface treatment of a recording material via heating section.

In other words, control section S is provided with such as a CPU to perform a calculation control process, a ROM to memorize various motion programs and a RAM to memorize calculation result data. Further, control section S has a constitution to read in outputs of various sensors via interfaces and to perform motion control of such as a motor or a display section based on the information.

P1, P2 and P3 are recording material storing sections (hereinafter, referred to as a paper storing section) to store recording material (hereinafter, referred to as paper) P and each constitution is basically identical.

In a sending out part of paper storing sections (P1-P3), paper feeding rollers 503, 513, and 523; separation rollers 506, 516 and 526; and transport rollers R1, R2 and R3 are provided, and paper P sent out is conveyed along the transport path on which transport rollers R4-R7 are arranged.

59 is a resist roller and arranged downstream to transport roller R7 and at the position adjacent to the second transfer section. Downstream to the second transfer section (the position where transfer roller 510 is arranged), arranged is fixing apparatus T, which is a heating section, comprising first fixing roller T1 including a heat source and the second fixing roller T2 which rotates while being in press contacting with the said first fixing roller, as the primary elements.

At the downstream position of the fixing roller pair, provided is surface treatment apparatus 8 which performs a surface treatment of a recording material baring a toner image having been heat treated with fixing apparatus T. Surface treatment apparatus 8 functions as a glossiness providing apparatus to provide glossiness. Surface treatment apparatus 8 is provided a heating section (not shown in the drawing: hereinafter, referred to as a thermal heads for convenience of an explanation) constituted by linearly arranging many dotted heating resistances (hereinafter, simply referred to as heating elements), and it is possible to selectively provide glossiness on the whole region or an arbitrary partial region of a toner image by current control of heating elements. Further, surface treatment apparatus 8 is provided with a cooling section to cool paper; however, the detailed constitution will be described later.

600 is a paper feed-out roller, and 680 is a feed-out paper tray to accumulating store paper having been fed out Since the form of paper transport path to constitute reversing feed-out paper•re-feeding paper section 6 and reversing transport section 7, or transport control is well known in the art and not directly related to this invention, the explanation will be omitted.

Next, processes from transfer of color toner images formed on intermediate transfer belt 401 until feed-out of paper outside the apparatus will be briefly explained.

At an appropriate timing corresponding to an image forming process, for example, paper P is fed by paper feeding roller 503. Successively, paper P is transported toward resist roller 59 while being nipped by separation roller 506 and a plural number of transport roller R1 and R5-R7 arranged on a transport path. Paper P to be fed is specified•selected on operation display board 150 which can set such as a number of sheets for recording, a recoding start button or an image density.

Paper P, after the top edge of which having been brought in contact with resist roller 59, is re-fed so as to be accumulated on a color toner image region on intermediate transfer belt 401 by rotation restart of said resist roller 59. Successively, paper P is pressing nipped, together with intermediate transfer belt, by backup roller 410 and transfer roller 510 in the second transfer section, and meanwhile, a color toner image on intermediate transfer belt 401 is transferred on paper P.

Paper P on which a toner image has been transferred is separated from intermediate transfer belt 401 to be transported toward fixing apparatus T by a transport belt (not shown in the drawing) and subjected to a heating•pressing treatment there. In the case that an order of glossiness application against a specific portion on a toner image having been heat treated with fixing apparatus T is made, current is flowed through heating elements (not shown in the drawing) in a predetermined portion to make a specified partial region to be highly glossy. Paper P having passed through surface treatment apparatus 8 is fed out onto paper feed-out tray 650 via paper feed-out roller 600.

On the other hand, the surface of intermediate transfer belt 401 after finishing the second transfer is subjected to cleaning with cleaning section 40 to be prepared for carrying a new toner image.

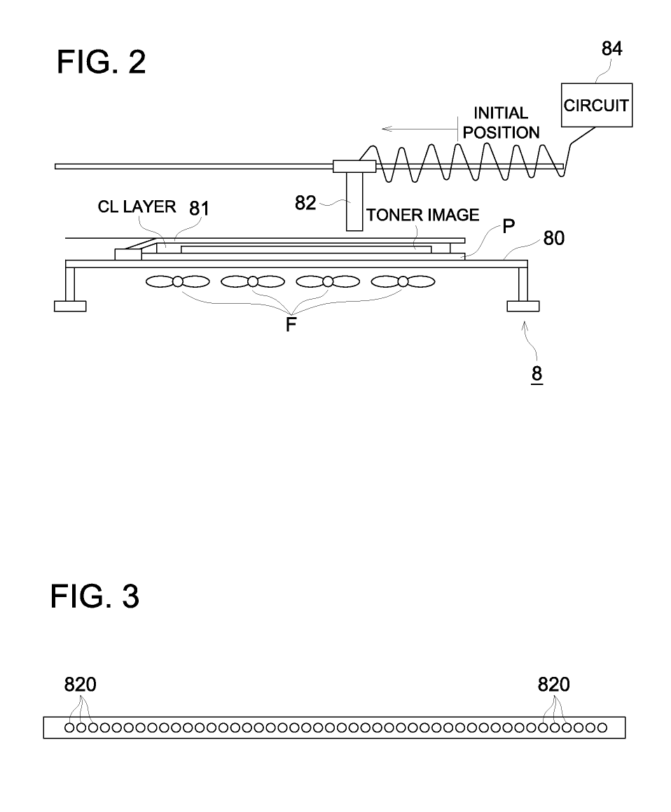

Next, a glossiness providing treatment according to this invention will be explained in reference to the constitution according to FIG. 1. FIG. 2 is an explanation drawing to conceptually show the first embodiment of a surface treatment apparatus.

In the drawing, paper P having been heat treated by a fixing apparatus is horizontally placed on cooling and peeling table 80 with making the toner image surface upward to be kept in a rest state. Further, the upper surface of paper P carrying a toner image is covered with resin film 81 and the both are fixed in a contact state. Resin film 81 in the embodiment of this invention has a sheet form.

Thermal head 82 is provided above resin film 81 so as to be horizontally shiftable. The thermal head is an assembly provided with many dotted heating elements 820 arranged linearly, as shown in FIG. 3, and the aforesaid heating elements 820 are individually controlled with respect to on-off of the current flow. Thermal head 82 is arranged so as to make heating elements 820 arranged linearly be positioned along the direction perpendicular to the proceeding direction of paper P. The current ON/OFF control over heating elements 820 is performed selectively depending on an image data including an arbitrary partial region related to a glossiness treatment, and performed via drive circuit 84 which is provided in one body with a thermal head driven under the control of control section S. Preparation of an image data desiring glossiness treatment can be covered by a technology well known in the art such as to arrange a region setting section on operation display board 150 and read-in a data set by said region setting section with control section S. The detailed explanation will be omitted since such an image data preparation is not directly related to this invention. Herein, as a partial region related to glossiness application includes the portion such as appropriate characters, for example, characters of “confidential”, or symbols and patterns being formed in an unspecified portion in a toner image region by a thermal head (identical with heating elements). Such characters can be prepared by adopting a constitution to appropriately be read out from a ROM of control section S.

Herein, on the opposite side of a thermal head relative to paper P, cooling section F comprising a fan to cool paper P is provided.

A glossiness treatment by a surface treatment apparatus for recording material having such a constitution is per formed in the following manner. After paper P, having been heat treated with fixing apparatus T is transported to be set on cooling peeling table 80 of surface treatment apparatus 8 and is covered with resin film 81, thermal head 82 is shifted toward the scanning direction (the left direction in the drawing) from the initial position at a predetermined speed. During relative shift of paper P and thermal head 82, current flow of heating elements 820 at a predetermined portion is on via drive circuit 84, and thermal energy of said heating elements is transmitted to a toner image via resin film 81 to melt the toner (image) in a predetermined region. At this time, adhesion of paper P and resin film 81 sandwiching the toner image is promoted to provide high glossiness on said region. Further, higher glossiness compared to that in a region without a glossiness treatment is provided also on a partial region corresponding to the aforesaid form of such as characters and patterns (a portion which coincides with the form of characters and patterns).

The back surface of paper P is cooled with cooling section F during a glossiness treatment, and separation of paper P and resin film 81 is performed after finishing a glossiness providing process. Cooling section F is provided as a section to enable paper separation in a short time after the surface treatment, however, cooling section F may be omitted in an embodiment to separate said paper after an appropriate time during natural cooling of the paper.

Herein, the constitutions of each section in this embodiment provided with resin film of a sheet form changeable for every one time use is as follows.

Shift speed of thermal head: 25 mm/second

Temperature of heating elements: 200° C.

Heating elements of thermal head: 8 dot/mm and total length of 350 mm

Resin film: PI resin having thickness of 25 μm

As a result of measurement at measurement angle of 20° with respect to a portion provided with glossiness by heating with heating elements by use of a gloss meter (GM268, manufactured by Minolta Corp.) according to a mirror surface photometric measurement method defined in JIS Z8741, a glossiness from 80 to 90 was obtained.

Further, glossiness of the region without glossiness application, that is, without a heat treatment was not more than 30.

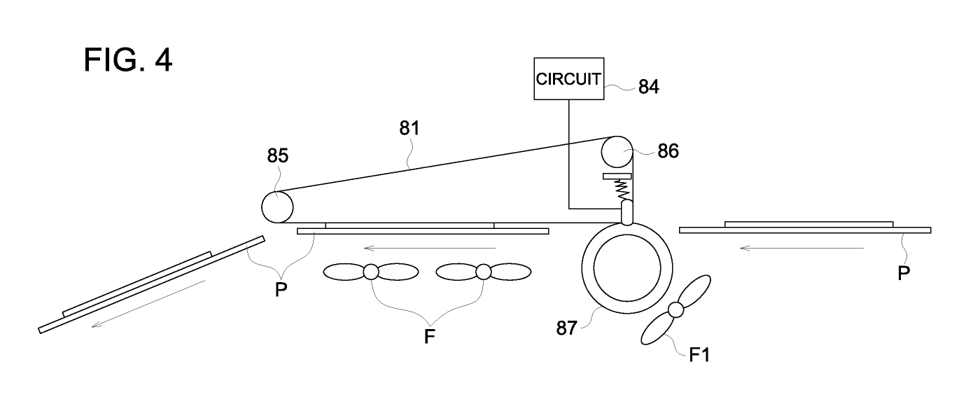

Next, the second embodiment of FIG. 2 according to a glossiness providing treatment will be explained in reference to FIG. 4. FIG. 4 is an explanation drawing to conceptually show a constitution of a glossiness providing apparatus. In the drawing, the same reference numbers are labeled on members (section) having the same functions with the members (section) already described. Further, since the principle with respect to glossiness application is basically same with the explanation of the first embodiment of FIG. 2, the explanation will be simply described.

In the constitution of FIG. 4, a different point from the first embodiment is to perform a partial glossiness providing treatment without stopping paper P.

Specifically, the second embodiment is provided with a constitution utilizing resin film as a belt form (hereinafter, referred to as resin belt 81 for convenience), which is rotatably hanged utilizing drive roller 85, subordinate roller 86 and thermal head 82 at a fixed position. Rotatable pressure roller 87 is arranged in a state of adhesion or adhesion releasable, at the position opposing to the head surface of aforesaid thermal head 82 sandwiching a resin belt. Thermal head 8 is an assembly provided with many dotted heating elements 820 linearly arranged as shown in FIG. 3 and the aforesaid heating elements 820 are individually controlled with respect to on-and-off of current flow. Thermal head 8 is arranged so as to position heating elements 820, which are linearly arranged, along the direction perpendicular to the proceeding direction of paper P. Current ON/OFF control against heating elements 820 is performed selectively depending on an image data including an arbitrary partial region related to a glossiness treatment, and is performed via drive circuit 84 arranged in a thermal head, which is driven under control of control section S, as one body. A partial region related to glossiness application also includes such as characters, symbols and patterns described in the first embodiment.

Drive roller 85 is constituted to have a small diameter to promote separation of paper P from resin belt 81 after a glossiness treatment, and functions as a separation roller. Opposing to the outer side (surface) of resin belt 81 hanging arranged between drive roller 85 and thermal head 82, cooling section F comprising a fan is provided. Further, the second cooling section F1 comprising a fan is arranged opposing to a part of the circumference surface of pressure roller 87.

In such a constitution, when paper P having been heat treated with a fixing apparatus is sent into surface treatment apparatus 8, paper P is conveyed at the same speed with the shift speed of resin belt 81. The heating elements at a specific portion of heating elements (not shown in the drawing) constituting thermal head 82 are ON/OFF controlled to flow current depending on an image data for glossiness application, and toner in the corresponding portion is fused.

At this time, adhesion of paper P and resin belt 81 sandwiching a toner image is kept, and the region heated with heating elements is provided with high glossiness. Next, paper P is cooled with cooling section F in a state of adhering on resin film 81, and is separated from resin belt 81 by a curvature function of drive roller 85 to be fed out. Adhesion between a thermal head and a pressure roller is released after finishing a glossiness providing treatment. The above-described constitution can improve recording efficiency since it never stops paper P during a glossiness providing treatment

Herein, as a result of measuring the portion having been provided with glossiness by being heated with heating elements, by use of a gloss meter described in an explanation according to FIG. 2 at a measurement angle of 20°, glossiness of approximately 80 was obtained. Further, the glossiness of a region without a glossiness treatment was approximately 30-40.

A toner image in this embodiment is not provided with clear toner layer CL on its surface; however, it is natural that clear toner layer CL can be provided. In the case of providing a clear toner layer, it is possible to form the form of such as said characters and symbols and to provide high glossiness on the portion thereof, for example, even when a part of the form of such as the above-described characters and symbols is present in a region without a toner image.

Herein, the constitutions of each section in this embodiment are as follows.

Resin belt: PI resin having thickness of 25 μm, φ300 mm

Shift speed of resin belt: 120 mm/second

Pressure roller: metal support provided with a rubber layer having thickness of 10 mm, φ100 mm

Drive roller: metallic roller, φ120 mm

Temperature of heating elements: 200° C.

Heating elements of thermal head: 8 dot/mm, total length of 350 mm

Pressing load of pressure roller against thermal head: 80 N

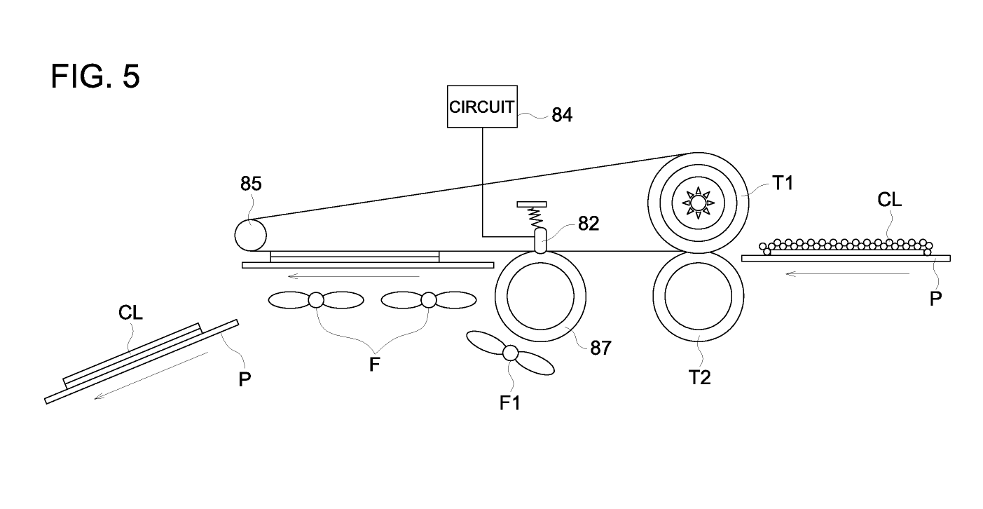

Next, the third embodiment according to a glossiness providing treatment will be explained in reference to FIG. 5. FIG. 5 is an explanation drawing to conceptually show a constitution of a surface treatment apparatus. In the drawing, the same reference numbers are labeled on members (section) having the same function with the members (section) already described. With respect to the principle related to glossiness application, the explanation will be made simply since it has been already made in an embodiment described before.

A different point from the constitution shown in FIG. 4 is a constitution to utilize drive roller 85 and first fixing roller T1 of fixing apparatus T (confer FIG. 1) as a section to stretching set resin belt 81. In other words, first fixing roller T1 and second fixing roller T2 are in a state of being adhered while sandwiching resin belt 81. Thermal head 82 and rotatable pressure roller 87 are arranged so as to adhere and/or be adhesion releasable while sandwiching the under horizontal portion of resin belt 81 which is stretched between first fixing roller T1 and drive roller 85. A toner image on paper P in this embodiment is provided with clear toner layer CL as the surface layer. In the above-described constitution, a toner image before fixing is subjected to a fixing treatment onto paper P by sending paper P, which carries a toner image before fixing on its upper surface, into fixing apparatus T and nipping•conveying it by first fixing roller T1 and second fixing roller T2. Successively, paper P is introduced to the opposing position of thermal head 82 along with shift of resin belt 81, and is subjected to a glossiness providing treatment there. A glossiness providing treatment is conducted by controlling a current flow of heating elements selectively at a specific portion among heating elements linearly arranged along the direction perpendicular to the proceeding direction of paper P, depending on an image data including arbitrary partial region related to a glossiness treatment.

A partial region related to glossiness application also includes the unspecified partial portion in the case that appropriate characters, for example characters of “confidential”, or a faun such as symbols and specific patterns are formed in an unspecified portion of a toner image by use of a thermal head (identical with heating elements). Such characters can be achieved by adopting a constitution to appropriately being read out from a ROM of control section S. A partial region including a partial portion corresponding to the aforesaid form such as characters and patterns (which means a portion coincide with a form of characters and patterns) and being heated with heating elements is provided with higher glossiness compared to a non-heated region. Successively, paper P is cooled by cooling section F in a state of adhering onto resin belt 81 and is separated from resin belt 81 by a curvature function of drive roller 85 to be fed out. After a glossiness providing treatment, adhesion between thermal head 82 and pressure roller 87 is released.

The above-described constitution can improve recording efficiency since it never stops paper P during a glossiness providing treatment. Further, since it can maintain a fused state of toner for a long time by heat possessed by resin belt 81, adhesion between toner and resin belt becomes strong at the time of heating with heating elements to enable stable glossiness application.

Herein, as a result of measuring the portion provided with glossiness by heating with heating elements at a measurement angle of 20° by use of a gloss meter described in an explanation according to FIG. 2, a glossiness of 80-90 was obtained. Further, glossiness of the region without a glossiness treatment was approximately 30-40.

Herein, constitutions of each section in this embodiment are as follows.

Resin belt: PI resin having thickness of 25 μm, φ300 mm

Shift speed of resin belt: 120 mm/second

Pressure roller: metal support provided with rubber layer having thickness of 10 mm, φ100 mm

Drive roller: metallic roller, φ20 mm

Temperature of heating elements: 200° C.

Heating elements of thermal head: 8 dot/mm, total length of 350 mm

Pressing load of pressure roller against thermal head: 80 N

Herein, in the second and third embodiments in which the above-described resin belt is utilized, it is desirable to adopt a constitution to utilize PI resin having an appropriate thickness such as 25 μm as a substrate (a base material) and to form a surface layer (a releasing layer) by coating a fluorine type resin such as PFA thereon. By adopting such a constitution, prevention of toner from adhering on the belt surface is possible to enable a more stable glossiness providing treatment. Further, the thermal conductivity is improved by incorporating carbon black in a PI belt. Thereby, heating and cooling become further advantageous, and even when the belt thickness is further increased, it is also possible to improve durability in addition to obtain abilities same with those of a thickness before incorporation of carbon black. A PI belt thickness of 25 μm and a shift speed of 120 mm/second are preferable; however, glossiness can be obtained even with a PI belt thickness of 50 μm in the case of conveying paper at a line speed of 80 mm/second. A thickness of the surface layer of approximately 10-20 μm is practical, and the surface roughness Ra of said surface layer is preferably approximately 0.01-0.1 μm. When glossiness application is desired, there is a demerit of not achieving high glossiness due to transfer of roughness onto the image surface in the case of surface roughness of over 0.1 μm.

Next, the forth embodiment will be explained in reference to FIG. 5 again. Herein, different points from the constitution shown in FIG. 5 at the time of the explanation of the third embodiment are the thickness of a resin belt being increased and fine roughness having a depth of 2-5 μm and a cross section of a rectangular faun being formed over the whole surface of a resin belt. Fine roughness can be formed by a laser processing. Since the mechanical constitution other than these points is identical with the third embodiment, the explanation may be omitted, however, will be made for confirmation.

First fixing roller T1 and second fixing roller T2 are in a state of being adhered sandwiching resin belt 81. Thermal head 82 and rotatable pressure roller 87 are arranged so as to adhere and/or be adhesion releasable while sandwiching the under horizontal portion of resin belt 81 which is stretched between first fixing roller T1 and drive roller 85. A toner image on paper P in this embodiment is provided with clear toner layer CL as the surface layer. In the above-described constitution, a toner image before fixing is subjected to a fixing treatment onto paper P by sending paper P, which carries a toner image before fixing on its upper surface, into fixing apparatus T and nipping•conveying it by first fixing roller T1 and second fixing roller T2. Successively, paper P is introduced to the opposing position of thermal head 82 along with shift of resin belt 81. At this time, the surface form on a resin belt in the corresponding portion is transferred on paper by controlling a current flow of heating elements at a specific portion among heating elements (not shown in the drawing: confer FIG. 3) linearly arranged along the direction perpendicular to the proceeding direction of paper P, depending on an image data including arbitrary partial region.

A partial region related to glossiness application also includes unspecified partial portion in the case that appropriate characters, for example characters of “confidential”, or a form such as symbols and specific patterns are formed in an unspecified portion of a toner image by use of a thermal head. Such characters can be achieved by adopting a constitution to be appropriately being read out from a ROM of control section S. A partial region including a partial region corresponding to the aforesaid form such as characters and patterns (which means a portion coincide with a form of characters and patterns) and being heated with heating elements is provided with a predetermined glossiness. Successively, paper P is cooled by cooling section F in a state of adhering on resin belt 81 and is separated from resin belt 81 by a curvature function of drive roller 85 to be fed out. After a glossiness providing treatment, adhesion between thermal head 82 and pressure roller 87 is released.

The above-described constitution can improve recording efficiency since it never stops paper P during a glossiness providing treatment. Further, since it can maintain a fused state of toner by heat possessed by resin belt 81 for a long time to strengthen adhesion between toner and a resin belt at the time of heating with heating elements, table glossiness application is possible. Herein, as a result of measuring the portion provided with roughness on the image surface by heating with heating elements, at a measurement angle of 20° by use of a gloss meter described in an explanation related to FIG. 2, a glossiness of 5-10 was obtained. Further, a glossiness of the region without a glossiness treatment was approximately 30-40.

Herein, constitutions of each section in this embodiment are as follows.

Resin belt: PI resin (containing carbon black) having thickness of 50 μm, φ300 mm

Shift speed of resin belt: 120 mm/second

Pressure roller: metal support provided with rubber layer having thickness of 10 mm, φ100 mm

Drive roller: metallic roller, φ20 mm

Temperature of heating elements: 200° C.

Heating elements of thermal head: 8 dot/mm, total length of 350 mm

Pressing load of pressure roller against thermal head: 80 N

Herein, also in the second to forth embodiments described above, a cooling section can be omitted in the case of the surface treatment speed (identical with paper conveying speed) being slow.

Further as for clear toner for clear toner layer formation, a toner described in such as JP-A 4-278967, which has been applied by the applicant of this invention, can be utilized.

In these embodiments, since a predetermined portion of a heating section provided with many dotted heating elements on a straight line is controlled with respect to current flow under a state of shifting the aforesaid heating elements relative to a recording material, for example, an arbitrary partial region in a toner image can be provided with glossiness. Further, such as characters, symbols and patterns can be appropriately formed by utilizing the surface form of a film belt. Furthermore, a high glossiness application is possible against an arbitrary partial region in a toner image after having been subjected to a heat treatment, by performing a treatment for partial glossiness application.

What is claimed is:

1. A surface treatment apparatus for recording material, comprising:
a resin film to be adhered to a surface of a toner image of which whole region has been heat treated, carried on the recording material;
a heating section including a plurality of heating elements provided on an opposite side of the recording material relative to the resin film; and
a control section which controls the heating section,
wherein the control section performs a current control of a predetermined part of the plurality of heating elements selectively in a state where the recording material and resin film contacts each other and the recording material moves relatively to the heating section.

2. The surface treatment apparatus for recording material described in claim 1, wherein the control section performs the current control of the heating elements in responding to the image data.

3. The surface treatment apparatus for recording material described in claim 1, wherein the resin film is sheet shaped.

4. The surface treatment apparatus for recording material described in claim 1, wherein the resin film is belt shaped.

5. The surface treatment apparatus for recording material described in claim 1, further comprising a cooling section provided on an opposite side of the heating section relative to the recording material.

6. The surface treatment apparatus for recording material described in claim 5, wherein the cooling section includes a fan.

7. The surface treatment apparatus for recording material described in claim 1, wherein the heating section is positioned along the direction perpendicular to the proceeding direction of the recording material.

8. An image forming apparatus comprising:
an image forming section which forms a toner image on an image carrier;
a transfer section which transfers the toner image to the recording material;
a fixing device which perform the heat treatment to the recording material having the toner image transferred; and
a surface treatment apparatus for recording material, which comprises:
a resin film to be adhered to a surface of a toner image of which whole region has been heat treated, carried on the recording material;
a heating section including a plurality of heating elements provided on an opposite side of the recording material relative to the resin film; and
a control section which controls the heating section,
wherein the control section performs a current control of a predetermined part of the plurality of heating elements selectively in a state where the recording material and resin film contacts each other and the recording material moves relatively to the heating section.

9. The image forming apparatus described in claim 8, further comprising a developing apparatus which forms a resin layer containing no colorant, to the recording material, prior to heating by the heating section.

10. The surface treatment apparatus for recording material described in claim 8, further comprising a cooling section provided on an opposite side of the heating section relative to the recording material.

11. The surface treatment apparatus for recording material described in claim 10, wherein the cooling section includes a fan.

12. The surface treatment apparatus for recording material described in claim 8, wherein the heating section is positioned along the direction perpendicular to the proceeding direction of the recording material.

13. A surface treatment method for recording material, comprising:
adhering a resin film to a surface of a toner image of which whole region has been heat treated, carried on the recording material; and
performing a current control, by a heating section including a plurality of heating elements provided on an opposite side of the recording material relative to the resin film, of a predetermined part of the plurality of heating elements selectively in a state where the recording material and resin film contacts each other and recording material moves relatively to the heating section.

14. The surface treatment method for recording material described in claim 13, wherein the current control of the heating elements is predetermined in responding to the image data.

15. The surface treatment method for recording material described in claim 13, wherein the resin film is sheet shaped.
